(19) United States
(12) Patent Application Publication
(10) Pub. No.: US 2020/0041262 A1
(43) Pub. Date: Feb. 6, 2020

(54) METHOD FOR PERFORMING CALIBRATION BY USING MEASURED DATA WITHOUT ASSUMED CALIBRATION MODEL AND THREE-DIMENSIONAL SCANNER CALIBRATION SYSTEM FOR PERFORMING SAME

(71) Applicant: Kallion, Inc., Daejeon (KR)

(72) Inventor: Chul Hee Lee, Daejeon (KR)

(73) Assignee: Kallion, Inc., Daejeon (KR)

(21) Appl. No.: 16/473,719

(22) PCT Filed: Apr. 5, 2017
(86) PCT No.: PCT/KR2017/003712

§ 371 Date: Oct. 1, 2019

(51) Int. Cl. G01B 11/25; G06T 7/80; G01B 11/03

(52) U.S. Cl. CPC G01B 11/2504; G01B 11/03; G01B 11/2518; G06T 7/85

(57) ABSTRACT

A three-dimensional scanner calibration system comprises: a three-dimensional coordinate providing means; a moving means for moving the three-dimensional coordinate providing means; and a control unit, wherein the control unit extracts three-dimensional coordinates at which the moved three-dimensional coordinate providing means is located and measures a relationship between each pixels of a camera and the three-dimensional coordinate providing means at the location of the three-dimensional coordinate providing means.

### TECHNICAL FIELD

Embodiments of the inventive concept described herein relate to a three-dimensional scanner calibration system and more particularly, relate to calibration technologies for directly estimating the equation of a ray passing through each pixel from real coordinates to minimize an error when performing calibration of a 3D scanning system which uses multiple cameras and multiple projectors.

### BACKGROUND ART

Recently, research has been actively conducted in three-dimensional scanners. Particularly, three-dimensional body scanner technology is applicable in very wide industry fields such as medical treatment, security, authentication, fashion, and manufacture.

A camera including an image sensor is used in a three-dimensional scanner, and camera calibration is essentially required. That is, points on three dimensions are projected on an image sensor by the camera. Where three-dimensional points are projected on the image is determined by a location and direction of the camera at a time when the image is captured.

However, a real image may be influenced by an optical part in the camera, for example, a used lens, a distance between the lens and an image sensor, or an angle defined by the lens and the image sensor. When a location where three-dimensional points are projected onto an image or when three-dimensional space coordinates are recovered from an image coordinate system, accurate calculation is possible only when such internal factors is removed.

Camera calibration may refer to a process of obtaining parameters for several elements in the above-mentioned process.

### DETAILED DESCRIPTION OF THE INVENTION

### Technical Problem

The inventive concept may measure a relationship between a three-dimensional coordinate providing means and each of pixels at a three-dimensional location projected on each of all pixels while moving the three-dimensional coordinate providing means to previously scheduled locations and may store the measured relation equation in a memory of a control system in the form of a table.

The inventive concept may more precisely derive intrinsic and extrinsic parameters based on a relation equation between each of pixels and a three-dimensional coordinate providing means at each of all pixels stored in the form of a table and may remove an error caused by the assumed calibration model.

Embodiments of the inventive concept may reduce an error which occurs in image processing by using at least one of a light emitting means, a projection means, or a reflective means as a three-dimensional coordinate providing means, may more accurately determine a three-dimensional location of the three-dimensional coordinate providing means, and may measure a relation equation for a ray for each pixel on the assumption of it to significantly reduce an error which occurs by assuming a calibration model.

The inventive concept may move a three-dimensional coordinate providing means using a step motor (a moving means) and a slide rail to more accurately determine and precisely control a three-dimensional location of a three-dimensional coordinate providing means.

Embodiments of the inventive concept may perform a calibration process for a location of a given three-dimensional coordinate providing means simultaneously using multiple cameras to reduce a time taken to perform the calibration.

### Technical Solution

According to an exemplary embodiment, a three-dimensional scanner calibration system may include a three-dimensional coordinate providing means that optically provides three-dimensional coordinates, a moving means that moves the three-dimensional coordinate providing means, and a controller. The controller may extract three-dimensional coordinates at which the moved three-dimensional coordinate providing means is located, may measure a relationship between each of pixels of a camera and the three-dimensional coordinate providing means at a location of the three-dimensional coordinate providing means, and may perform calibration based on the relationship.

The moving means may move the three-dimensional coordinate providing means at an interval narrower than an interval between the pixels.

The three-dimensional coordinate providing means may include at least one of a light emitting means including a light source, a projection means including a projector, or a reflective means on which a pattern is formed.

The controller may store the relationship between each of the pixels of the camera and the three-dimensional coordinate providing means at the location of the three-dimensional coordinate providing means and may calculate a parameter for calibration using the stored relationship.

When there are a plurality of cameras, the controller may measure a relationship between each of pixels of the camera and the three-dimensional coordinate providing means at the location of the three-dimensional coordinate providing means simultaneously for each of the cameras.

When there are a plurality of projectors, the controller may measure a relationship between each of the pixels of the camera and the three-dimensional coordinate providing means at the location of the three-dimensional coordinate providing means sequentially for each of the projectors.

The moving means may move the three-dimensional coordinate providing means depending on an adjusted movement speed.

According to an exemplary embodiment, a method for performing calibration using data without an assumed calibration model may include locating a three-dimensional coordinate providing means on a first location using a moving means and extracting three-dimensional coordinates at which the moved three-dimensional coordinate providing means is located, using a controller and measuring a relationship between each of pixels of a camera and the three-dimensional coordinate providing means at a location of the three-dimensional coordinate providing means.

The method may further include storing the relationship between each of the pixels of the camera and the three-dimensional coordinate providing means at the location of the three-dimensional coordinate providing means and calculating a parameter for calibration using the stored relationship.

The method may further include moving the three-dimensional coordinate providing means to a second location.

### Advantageous Effects of the Invention

The inventive concept may measure a relationship between a three-dimensional coordinate providing means and each of pixels at a three-dimensional location projected on each of all pixels while moving the three-dimensional coordinate providing means to previously scheduled locations and may store the measured relation equation in a memory of a control system in the form of a table.

The inventive concept may more precisely derive intrinsic and extrinsic parameters based on a relation equation between each of pixels and a three-dimensional coordinate providing means at each of all pixels stored in the form of a table and may remove an error caused by the assumed calibration model.

An embodiment of the inventive concept may reduce an error which occurs in image processing by using at least one of a light emitting means, a projection means, or a reflective means as a three-dimensional coordinate providing means, may more accurately determine a three-dimensional location of the three-dimensional coordinate providing means, and may measure a relation equation for a ray for each pixel on the assumption of it to significantly reduce an error which occurs by assuming a calibration model.

The inventive concept may move a three-dimensional coordinate providing means using a step motor (a moving means) and a slide rail to more accurately determine and precisely control a three-dimensional location of a three-dimensional coordinate providing means.

An embodiment of the inventive concept may perform a calibration process for a location of a given three-dimensional coordinate providing means simultaneously using multiple cameras to reduce a time taken to perform the calibration.

### DESCRIPTION OF THE DRAWINGS

FIG. 1 is a drawing illustrating a relationship among an image coordinate system, a camera coordinate system, and a world coordinate system (a real coordinate system);

FIG. 2 is a drawing illustrating a previously known calibration method;

FIGS. 3 and 4 are drawings illustrating a three-dimensional scanner calibration system to which a calibration method according to an embodiment of the inventive concept is applicable;

FIG. 5 is a drawing illustrating locating a three-dimensional coordinate providing means on a plurality of locations on a three-dimensional real coordinate system while moving the three-dimensional coordinate providing means and measuring a relation equation for the corresponding three-dimensional coordinate providing means at a location on a three-dimensional real coordinate system given for each pixel, according to an embodiment of the inventive concept; and

FIG. 6 is a drawing illustrating precisely moving a three-dimensional coordinate providing means using a slide rail.

### BEST MODE

Hereinafter, a description will be given in detail of embodiments of the inventive concept with reference to the accompanying drawings.

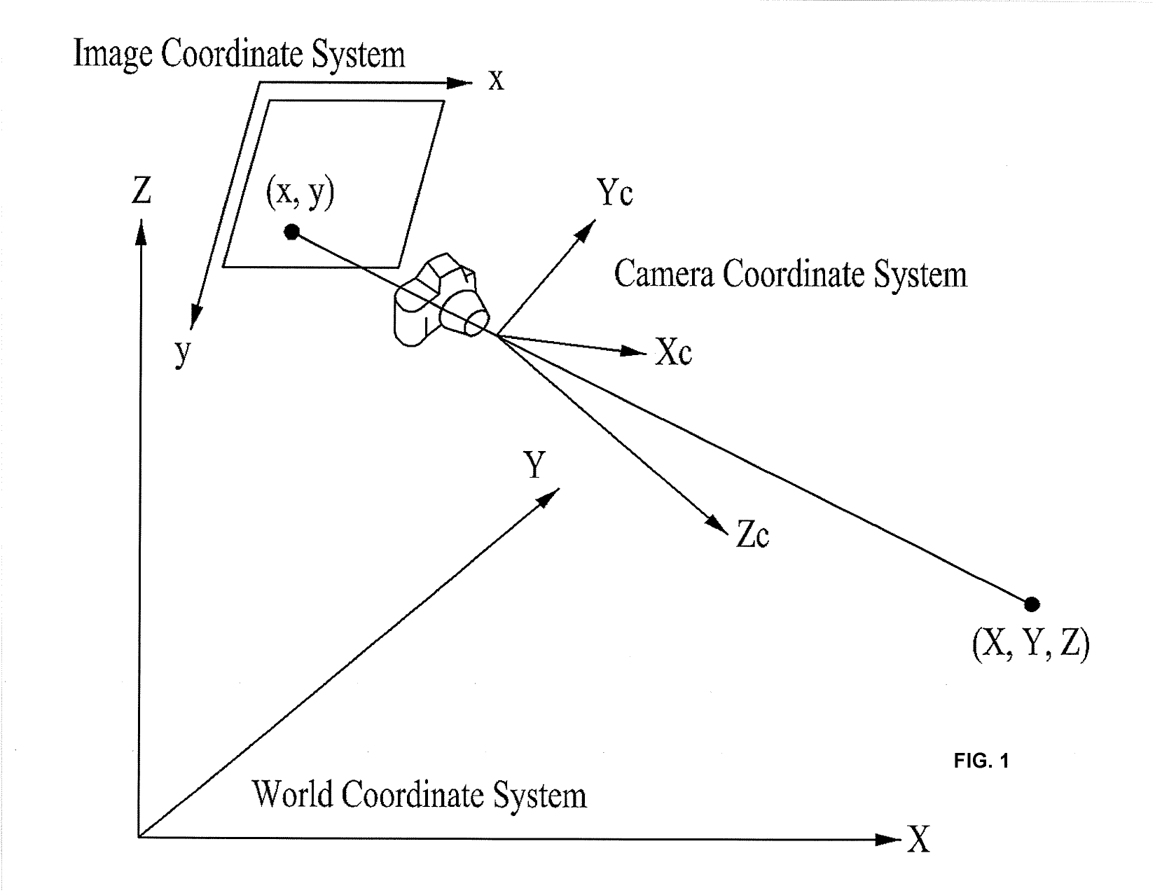

FIG. 1 is a drawing illustrating a relationship among an image coordinate system, a camera coordinate system, and a world coordinate system (a real coordinate system).

As shown in FIG. 1, the camera calibration may be a process of finding a conversion relationship between any point (X, Y, Z) on the world coordinate system and image coordinates (x, y) on a 2D image coordinate system or finding a parameter describing the conversion relationship. A description will be given of the relationship like Equation 1 below for a pinhole camera.

$$Equation 1$$

$$s [ \begin{matrix}x \\ y \\ 1\end{matrix} ] = [ \begin{matrix}{f}_{x} & {skew\_cf}_{x} & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ] = A [ R \text{\textbar} t ] [ \begin{matrix}X \\ Y \\ Z \\ 1\end{matrix} ]$$

At this time, [R/t] is called the extrinsic parameter of the camera, and A is called the intrinsic parameter of the camera.

At this time, a previously known calibration method assumes and estimates the extrinsic parameter and the intrinsic parameter as a suitable calibration model. That is, the previously known calibration method assumes that any point on the real coordinate system corresponds to a specific pixel on the image coordinate system based on a previously assumed calibration model and estimates the extrinsic parameter and the intrinsic parameter based on such assumption. Such a calibration method may include a modeling error caused by the assumed calibration model and a measurement error of a lens, an image sensor, or the like.

Although described below, embodiments of the inventive concept may significantly reduce an error of the previously known calibration method by removing the modeling error caused by the assumed calibration model. That is, embodiments of the inventive concept may perform calibration by estimating a ray for each pixel, rather than using the previously assumed calibration model.

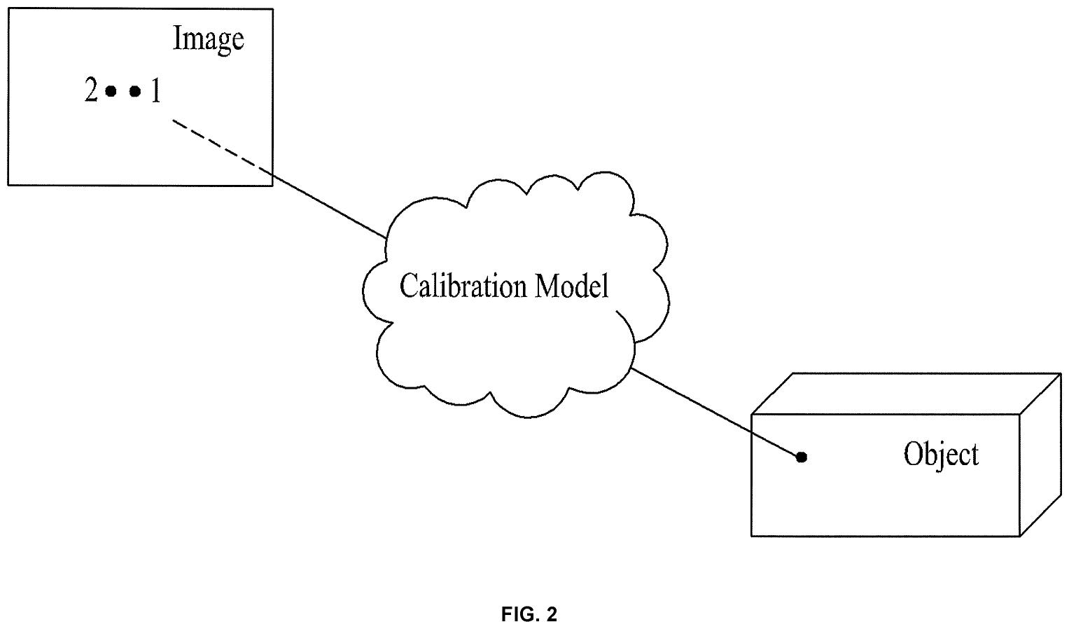

FIG. 2 is a drawing illustrating a previously known calibration method.

Referring to FIG. 2, the previously known calibration method may regard a relationship between any one point of an object which exists on a real coordinate system and a specific pixel on an image coordinate system as a previously assumed calibration model and may estimate intrinsic and extrinsic parameters using the assumed calibration model. At this time, when the assumed calibration model does not accurately indicate a real state, this causes an error and such an error is called a calibration error.

Referring to FIG. 2, describing an error caused by the assumed calibration model again, even though one point of an object actually corresponds to pixel 1, it may be regarded as corresponding to pixel 2 due to the error caused by the assumed calibration model and estimating intrinsic and extrinsic parameters of a camera on the assumption of such an error may naturally result in an incorrect result.

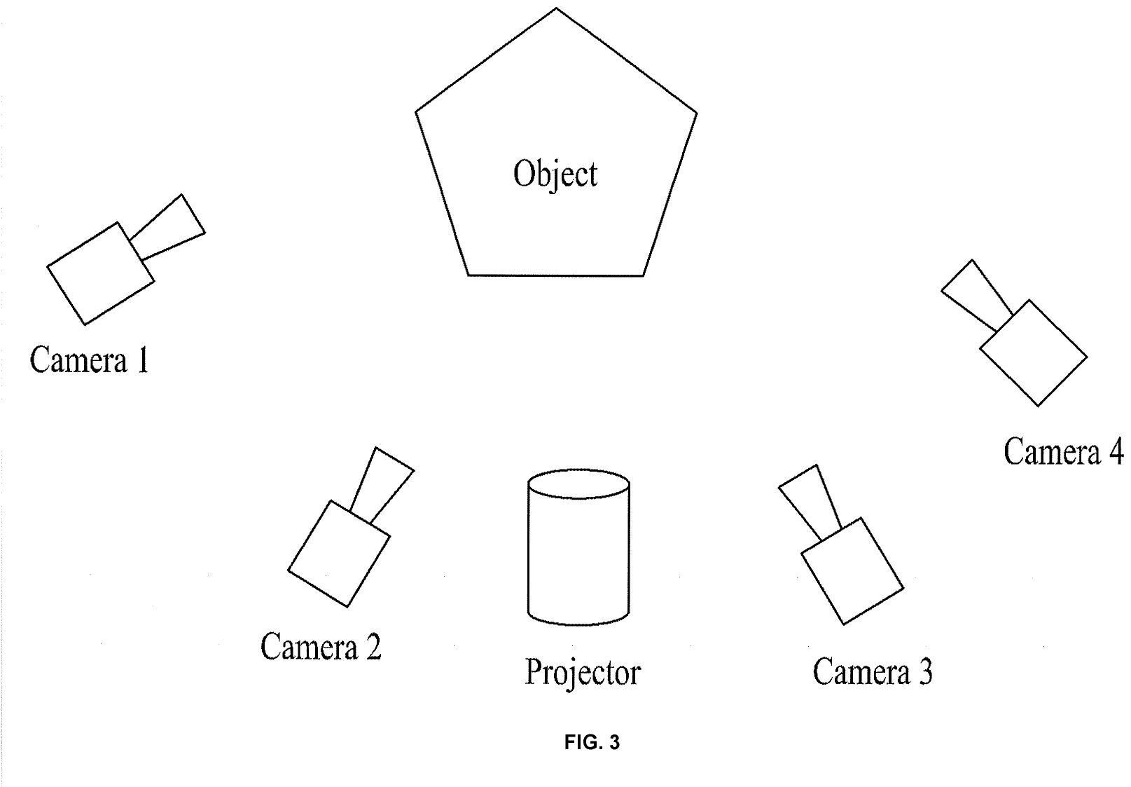

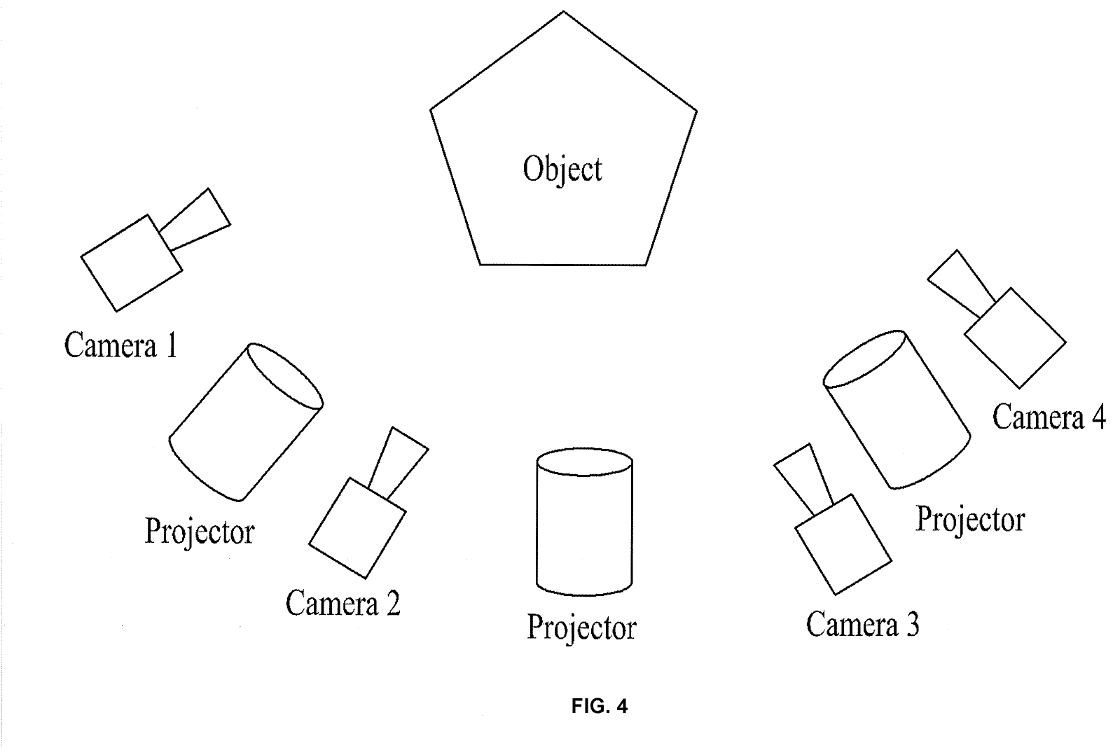

FIGS. 3 and 4 are drawings illustrating a three-dimensional scanner calibration system to which a calibration method according to an embodiment of the inventive concept is applicable.

Referring to FIGS. 3 and 4, the inventive concept is applicable to a three-dimensional scanner calibration system (FIG. 3) which uses a single projector and a plurality of cameras and a three-dimensional scanner calibration system (FIG. 4) which uses a plurality of projectors and a plurality of cameras. Of course, according to an embodiment, the inventive concept is applicable to a three-dimensional scanner calibration system (not shown) which uses a single projector and a single camera.

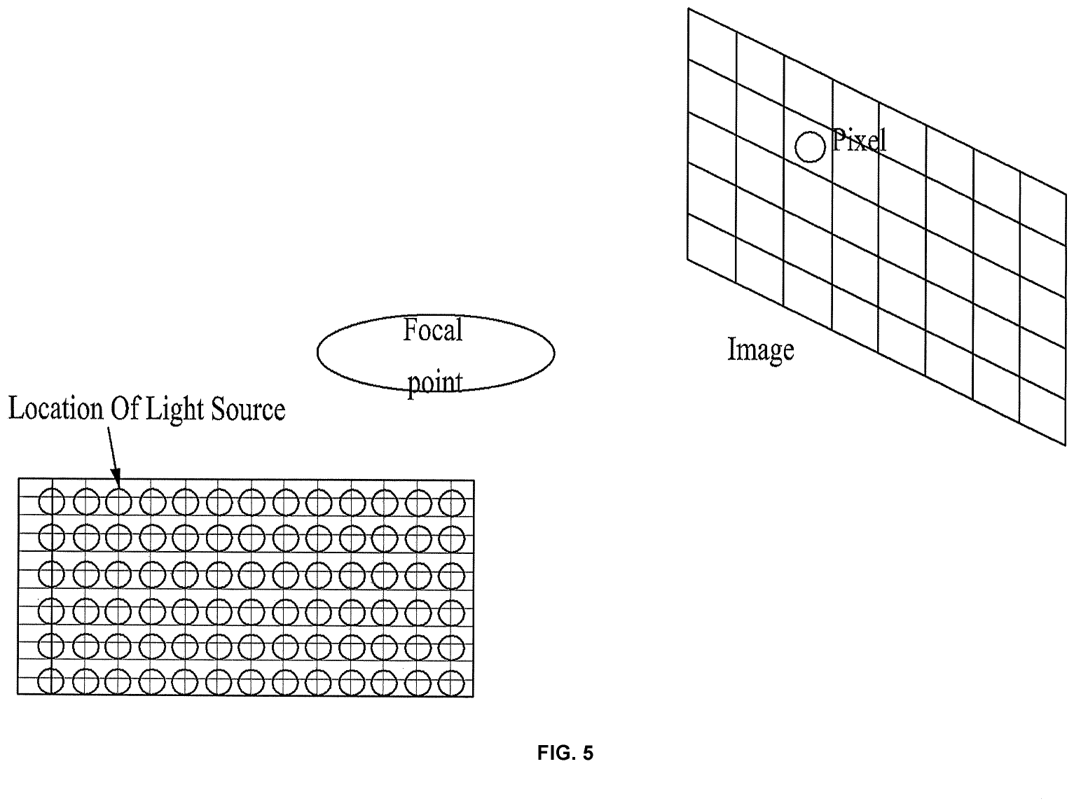

In FIG. 5, according to an embodiment of the inventive concept, it is assumed that a light source (which may be a point source which uses an LED or the like) as a light emitting means is used as a three-dimensional coordinate providing means. Of course, the three-dimensional coordinate providing means is not limited to the light emitting means, and a projection means including a projector or a reflective means on which a pattern is formed may be used.

While the light source moves, when the light source is put on a plurality of locations on a three-dimensional real coordinate system, a relation equation for the corresponding light source may be measured at a location on the three-dimensional real coordinate system given for each pixel.

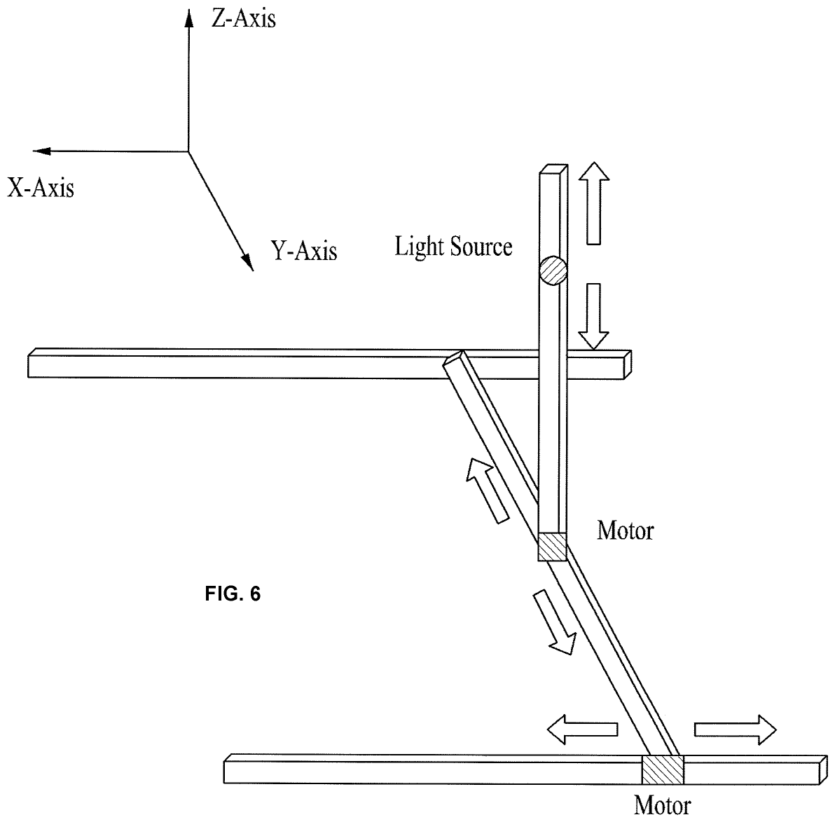

Referring to FIGS. 5 and 6, the light source sequentially moves at a predetermined interval. At this time, the predetermined interval may be shorter than an interval between pixels.

When the light source is put on a specific three-dimensional location, a relation equation between the light source and each of the pixels may be measured for a three-dimensional location given at each of pixels, and this may be stored in a memory of a control system (e.g., a PC) in the form of a table. For example, when the light source is located on a three-dimensional real coordinate system (X1, Y1, Z1), a relationship between pixel A and the light source or a relationship between pixel B and the light source may be separately measured. While the light source moves to the previously scheduled locations, a relationship between the light source and each of the pixels may be measured at a three-dimensional location given at each of all pixels, and the measured relation equation may be stored in the memory of the control system in the form of the table.

At this time, information stored in one item of the table may be represented as a straight line passing through three-dimensional coordinates projected onto a corresponding pixel, for example, coordinates of two points passing through the corresponding straight line.

When all relationships are measured and stored in the form of the table, a calibration process may be very precise. In other words, intrinsic and extrinsic parameters may more precisely derived based on a relation equation between each of pixels and the light source at each of all pixels stored in the form of the table, and such a method may remove an error caused by the assumed calibration model.

Furthermore, an embodiment of the inventive concept may reduce an error which occurs in image processing, by using at least one of a light emitting means including a light source, a projection means including a projector, or a reflective means on which a pattern is formed as the three-dimensional coordinate providing means. Because an embodiment of the inventive concept more accurately determines a three-dimensional location of the three-dimensional coordinate providing means and measures a relation equation for a ray for each pixel on the assumption of it, it significantly reduce an error which occurs by assuming a calibration model. Particularly, to more accurately determine and precisely control a three-dimensional location of the three-dimensional coordinate providing means, the inventive concept may move the three-dimensional providing means using a step motor (a moving means) and a slide rail.

FIG. 6 is a drawing illustrating precisely moving a three-dimensional coordinate providing means using a slide rail.

Referring to FIG. 6, the inventive concept may move a light source using a plurality of bars which are orthogonal to each other. That is, the light source may freely move in three directions of X, Y, and Z axes.

In this case, because a step motor is combined with the light source, the light source may move at a predetermined interval. It is preferable for the interval at which the light source moves is less than an interval between pixels.

When embodiments of the inventive concept is applied to a multi-camera three-dimensional scanner calibration system shown in FIGS. 3 and 4, in an embodiment of the inventive concept, multiple cameras may simultaneously perform a calibration process for a location of a given three-dimensional coordinate providing means, and this may reduce a time taken to perform the calibration. The description is given in detail above of the camera calibration.

When projector calibration is needed, after camera calibration is completed, the projector calibration may be sequentially performed for each of projectors using traditional three-dimensional scanning based on the result of performing the camera calibration. In this case, the location of the projector may be encoded by means of a pattern of light emitted by the projector.

The foregoing devices may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described exemplary embodiments of the inventive concept, or vice versa.

### MODE FOR INVENTION

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

1. A three-dimensional scanner calibration system, the system comprising:
a three-dimensional coordinate providing means configured to optically provide three-dimensional coordinates;
a moving means configured to move the three-dimensional coordinate providing means; and
a controller,
wherein the controller is configured to:
extract three-dimensional coordinates at which the moved three-dimensional coordinate providing means is located;
measure a relationship between each of pixels of a camera and the three-dimensional coordinate providing means at a location of the three-dimensional coordinate providing means; and
perform calibration based on the relationship.

2. The system of claim 1, wherein the moving means is configured to:
move the three-dimensional coordinate providing means at an interval narrower than an interval between the pixels.

3. The system of claim 1, wherein the three-dimensional coordinate providing means includes at least one of a light emitting means including a light source, a projection means including a projector, or a reflective means on which a pattern is formed.

4. The system of claim 1, wherein the controller is configured to:
store the relationship between each of the pixels of the camera and the three-dimensional coordinate providing means at the location of the three-dimensional coordinate providing means; and
calculate a parameter for calibration using the stored relationship.

5. The system of claim 1, wherein the controller is configured to:
when there are a plurality of cameras, measure a relationship between each of pixels of the camera and the three-dimensional coordinate providing means at the location of the three-dimensional coordinate providing means simultaneously for each of the cameras.

6. The system of claim 1, wherein the controller is configured to:
when there are a plurality of projectors, measure a relationship between each of the pixels of the camera and the three-dimensional coordinate providing means at the location of the three-dimensional coordinate providing means sequentially for each of the projectors.

7. The system of claim 1, wherein the moving means is configured to:
move the three-dimensional coordinate providing means depending on an adjusted movement speed.

8. A method for performing calibration using data without an assumed calibration model, the method comprising:
locating a three-dimensional coordinate providing means on a first location using a moving means;
extracting three-dimensional coordinates at which the moved three-dimensional coordinate providing means is located, using a controller and measuring a relationship between each of pixels of a camera and the three-dimensional coordinate providing means at a location of the three-dimensional coordinate providing means.

9. The method of claim 8, further comprising:
storing the relationship between each of the pixels of the camera and the three-dimensional coordinate providing means at the location of the three-dimensional coordinate providing means; and
calculating a parameter for calibration using the stored relationship.

10. The method of claim 8, further comprising:
moving the three-dimensional coordinate providing means to a second location.

11. A three-dimensional scanner calibration system, the system comprising:
a three-dimensional coordinate providing means configured to optically provide three-dimensional coordinates;
a moving means configured to move the three-dimensional coordinate providing means;
at least one projector; and
a controller,
wherein the controller is configured to:
extract three-dimensional coordinates at which the moved three-dimensional coordinate providing means is located, measure a relationship between each of pixels of a camera and the three-dimensional coordinate providing means at a location of the three-dimensional coordinate providing means, and perform calibration based on the relationship; and
perform projector calibration for the at least one projector based on the result of performing camera calibration.

12. A three-dimensional scanner system, the system comprising:
performing camera calibration or projector calibration using a three-dimensional scanner calibration system of claim of 1; and
performing scanning based on the result of performing the camera calibration or the projector calibration.
